(19) United States
(12) Patent Application Publication
(10) Pub. No.: US 2007/0290515 A1
(43) Pub. Date: Dec. 20, 2007

(54) Extendable and retractable bumper protection apparatus

(76) Inventor: Duc T. Doan, Los Angeles, CA (US)

Correspondence Address: Edward E. Roberts, P.O. Box 3206, Dana Point, CA, 92629, US

(21) Appl. No.: 11/452,575

(22) Filed: Jun. 15, 2006

(51) Int. Cl. B60R 19/40

(52) U.S. Cl. 293/119

(57) ABSTRACT

There is provided apparatus for protection of a vehicle from damage by other vehicles attempting to undesirably encroach to the front or rear of the vehicle. The apparatus includes extendable and retractable bumper portions that when extended form a safety enclosure for activities at the rear of a vehicle. The apparatus includes sensors for monitoring encroaching objects and may be electrically or hydraulically operated, either automatically or upon demand.

### BACKGROUND

The background of the invention will be discussed in two parts.

1. Field of the Invention

The present invention relates to a bumper protection apparatus for use in connection with a vehicle. The bumper protection apparatus has particular utility in connection with protecting a person during unloading or other activities at the rear of a stopped vehicle as well as providing protection for a parked vehicle from damage caused by other vehicles attempting to park behind or in front of it.

2. Description of the Prior Art

Bumper guard devices are known in the prior art. For example, U.S. Pat. No. 4,641,870 to Heyman discloses a bumper guard bolted to the automobile frame; however, it does not protect the rear of the vehicle to which it is affixed. U.S. Pat. No. 6,113,164 to Setina discloses an auxiliary push bumper that prevents damage to a vehicle when it pushes another vehicle, however, it does not protect the rear of the vehicle to which it is affixed. U.S. Pat. No. 2,736,287 to Moyes discloses a tailgate-supporting bumper-guard that will serve as a support for the outer or free end portion of the hingedly mounted tailgate when said tailgate is in its lowered, load supporting position, however, it does not protect the vehicle from damage resulting from contact with another vehicle. U.S. Pat. No. 2,203,489 to Conwell discloses an accessory bumper guard that applies to a conventional bumper structure, however, it does not protect the front of the vehicle to which is attached. U.S. Pat. No. 3,308,903 to Sobel et al. discloses a motor vehicle push preventing bumper guard that renders the power plant of a moving motor vehicle inoperative when it comes in contact with an obstruction such as another motor vehicle, however, it does not deter other vehicles from making contact with the vehicle to which the guard is attached. U.S. Pat. No. 2,083,742 to Poncher et al. discloses a bumper guard that mounts on the front and rear bumpers to protect the radiator and the trunk door, however, it does not deter other vehicles from making contact with the vehicle to which the guard is attached. U.S. Pat. No. 6,572,163 to Pickett discloses a bumper guard that mounts on the front and rear bumpers in a position to protect the radiator and the trunk door, however, the apparatus includes visual deterrents such as metal spikes for the purpose of protecting a parked vehicle from damage caused by other vehicles attempting to park adjacent to it.

While the above-described devices fulfill their particular objectives and requirements, they do not describe a bumper protection apparatus that allows protecting a parked vehicle from damage caused by other vehicles attempting to park to the front or rear of it, nor do they make provision for protecting a person having activities at the rear of a parked or stopped vehicle. Further, the devices do not deter other drivers from making damaging contact with the vehicle to which they are affixed nor are they universally attachable to a wide variety of vehicles. Thus, in view of the prior art there exists a need for a new and improved bumper protection apparatus that can be used for protecting a parked vehicle from damage caused by other vehicles attempting to park to the front or rear of it, as well as providing protection for a person during unloading or activities at the rear of the parked or stopped vehicle.

It is therefore an object of the present invention to provide a new and improved bumper protection apparatus that in substantially departing from the conventional concepts and designs of the prior art, provides unique apparatus for both protecting a parked vehicle and as well as protecting a person having activities at the rear of the parked or stopped vehicle.

It is another object of the present invention is to provide a bumper protection apparatus for protecting a parked vehicle from damage caused by other vehicles attempting to park to the front or rear of it, making it possible to visually and physically deter other drivers from placing their vehicle in the area covered by the bumper protection apparatus.

A further object of the present invention is to provide a bumper protection apparatus for protecting a person having activities at the rear of the parked or stopped vehicle.

Numerous other objects, features and advantages of the invention will be readily apparent to those of ordinary skill in the art upon a reading of the following detailed description when taken in conjunction with the accompanying drawings in which like reference numerals refer to like elements in the several views.

### SUMMARY

The present invention provides improved bumper protection apparatus having many novel features including protection of a stopped or parked vehicle from damage caused by other vehicles attempting to park, or otherwise undesirably encroach, to the front or rear of it, as well as providing protection for a person during unloading or other activities at the rear of the stopped or parked vehicle. The apparatus includes extendable and retractable bumper portions that when extended form a safety enclosure for activities at the rear of a vehicle as well as making it possible to visually and physically deter other drivers from placing their vehicle in the area covered by the bumper protection apparatus. The apparatus includes distance sensors and may be electrically or hydraulically operated, either automatically or upon demand.

### DRAWINGS

FIG. 1A is a perspective view of an embodiment of the bumper protection apparatus in accordance with the principles of the present invention with the apparatus shown in the retracted position;

FIG. 1B is a perspective view of the bumper protection apparatus of FIG. 1A with the apparatus shown in the fully extended position and illustrating the safety enclosure features of the invention;

FIG. 1C illustrates in side view the bumper protection apparatus of FIG. 1B and further shows the protective enclosure features of the invention;

FIG. 2A is a bottom view illustrating installation in a vehicle of the apparatus of the invention, the apparatus in the retracted position;

FIG. 2B is a bottom view illustrating installation in a vehicle of the apparatus of the invention, the apparatus in the extended position;

FIG. 3 is a functional block diagram depicting function of the apparatus of the invention as operated by electrical means;

FIG. 4A is a perspective view of the bumper protection apparatus of the invention shown installed in a delivery truck in the retracted position;

FIG. 4B is a perspective view of the bumper protection apparatus of FIG. 4A shown in the fully extended position and illustrating safety enclosure protective features of the invention;

FIG. 5A illustrates in side view the protective work space established for a large truck by the apparatus of the invention;

FIG. 5B illustrates in side view a vehicle approaching the protective work space established by the apparatus of the invention;

FIG. 5C illustrates in side view the bumper protection apparatus shown in FIG. 5B cushioning the impact of the approached vehicle;

FIG. 6A illustrates in side view a modified bumper apparatus in accordance with the invention, the apparatus in the retracted position;

FIG. 6B illustrates the bumper apparatus of FIG. 6A extended to conserve egress parking space as well as for impact damage prevention;

FIG. 7A illustrates front and rear installation of the invention in a vehicle bracketed by two other vehicles, the apparatus in the retracted position; and

FIG. 7B illustrates the bumper apparatus of FIG. 5A extended to conserve front and rear egress parking space as well as for impact damage prevention.

### DESCRIPTION

Referring to the drawings there is shown the bumper protection apparatus of the present invention. As will be described the bumper apparatus provides for protection of a stopped or parked vehicle from damage caused by undesirably encroaching vehicles either from the front or back, and as well provides a protected work space for unloading or other activities at the rear of the parked or stopped vehicle.

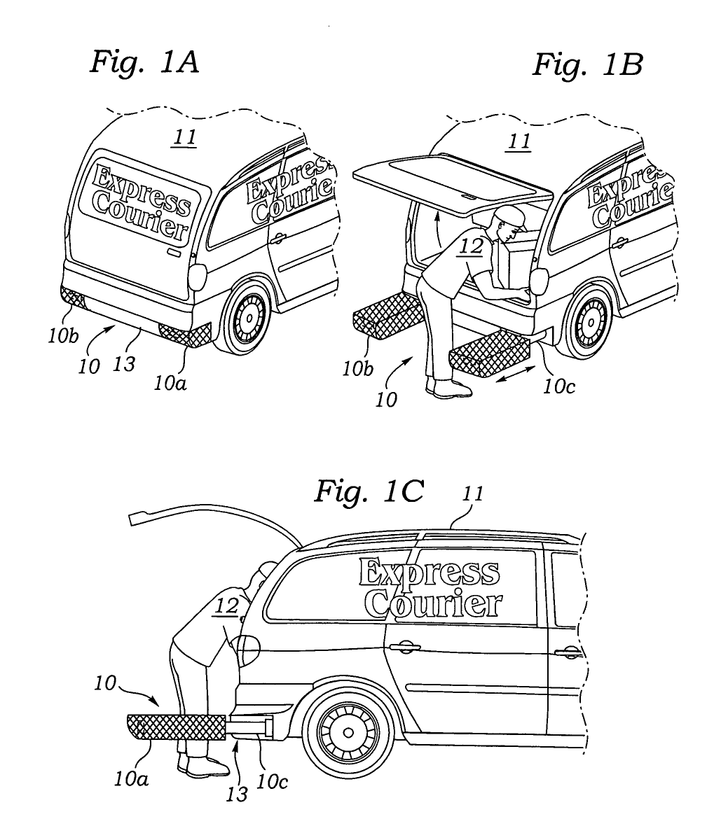

FIGS. 1A-1C illustrate the inventive features of the invention, FIG. 1A illustrating in perspective view the bumper protection apparatus 10 installed in a vehicle 11 in the retracted position or mode with FIG. 1B illustrating apparatus 10 in the fully extended position or mode. As shown in cross-hatch, the apparatus 10 includes substantially identical protective bumper apparatus portions 10a and 10b that may be formed as part of the rear bumper 13. FIG. 1C illustrates in side view the bumper protection apparatus 10 in the extended mode thereby defining, by apparatus portions 10a and 10b, a protected work space for loading or unloading activities at the rear of the vehicle. As indicated in FIGS. 1A-1C the apparatus 10 is suitable for a relatively small vehicle such as an automobile, a sport utility vehicle (SUV), or small panel truck. As will be explained infra the apparatus 10 may be extended and retracted by electrical means, by means of a hydraulic system, or by other suitable means in accordance with the invention.

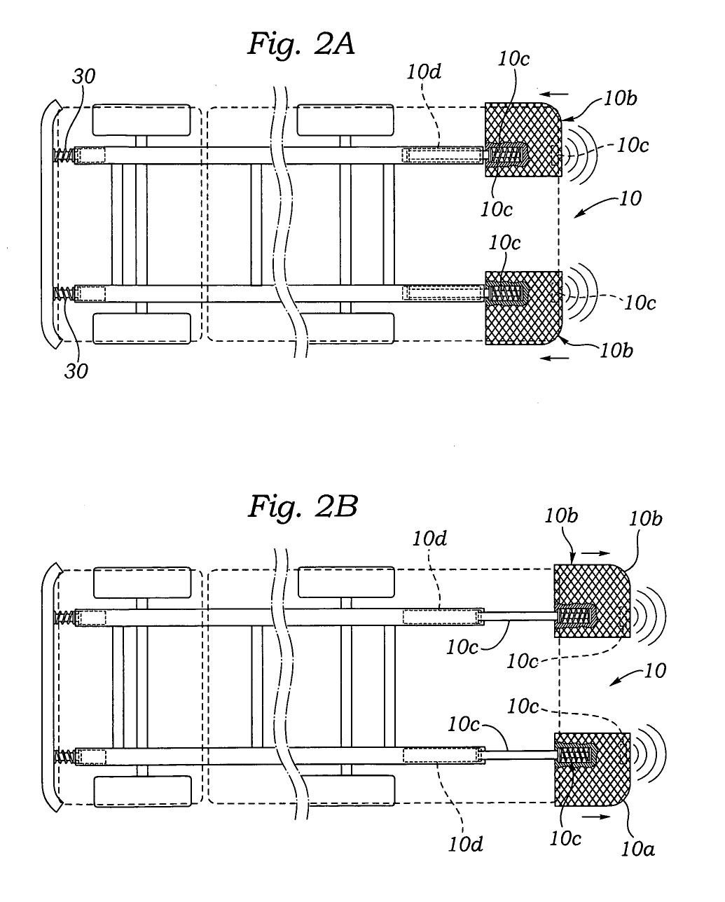

FIGS. 2A and 2b illustrate in bottom view the apparatus 10 of the invention in greater detail, FIG. 2A illustrating apparatus 10 in the retracted mode and FIG. 2B illustrating apparatus 10 in the extended mode. Only shock absorber means 30 are shown for the front bumper although it is to be understood that apparatus 10 as described may also be installed at the front end of the vehicle. As seen, bumper protection apparatus portions 10a and 10b have respectively substantially identical extension rods 10c and cylinders 10d for receiving extension rods 10c in the retracted mode (FIG. 2A). Bumper portions 10a and 10b further include built-in substantially identical shock absorbers 10e and safety sensors 10f. Bumper portions 10a and 10b may be of resilient material to allow for compression and reaction of shock absorbers 10e. Sensors 10f may be of a conventional sonar design or as may be found desirable.

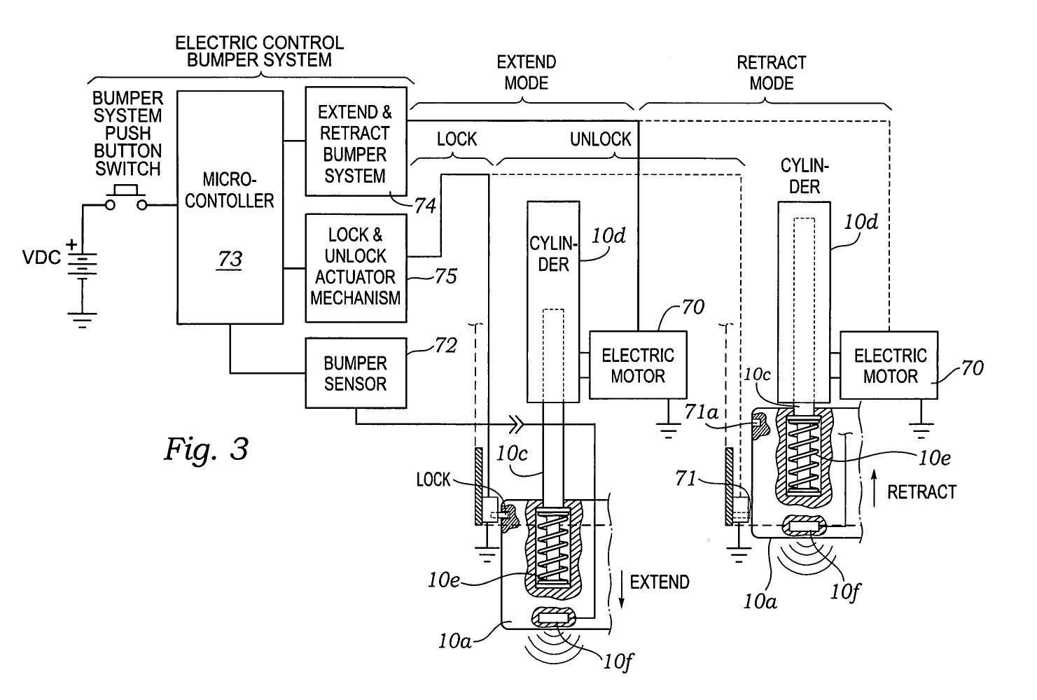

FIG. 3 is a functional block diagram depicting function of the apparatus in accordance with the invention as operated by electrical means for both the retracted and extended mode. Since bumper portions 10a and 10b are substantially identical except for left/right configuration only portion 10a will be described. For the retracted mode, safety bumper portion 10a is depicted having sensor 10f for sensing near proximity objects, shock absorber 10e for impact absorption, extension rod 10c, cylinder 10d for receiving extension rod 10c, and electric motor 70 for extending and retracting extension rod 10c and thus bumper portion 10a. Also shown is locking mechanism 71 and associated notch 71a for locking in place bumper portion 10a. Although only one notch means 71a is shown, it is understood that locking mechanism 71 could include means for locking bumper portion 10a in multiple selected extension positions. Further, although not shown, microcontroller 73 may include means for automatically unlocking locking mechanism 71 upon predetermined impact to allow compression of shock absorbers 10e. However, sensors 10f sense occupation of said work place and upon impact microcontroller 73 automatically selectively locks said bumper portions to maintain the safety of the work space. Microcontroller 73 may further include means for automatically extending and retracting bumper portions 10a, 10b in response to predetermined signals from sensors 10f. In addition, visual display means as well as audio means may be included for informing the vehicle operator of the extension/retraction status of the bumper portions 10a, 10b and microcontroller 73 may include manually switched means for extension/retraction of bumper portions 10a, 10b.

For the extended mode of bumper portion 10a the output of sensor 10f is fed to bumper sensor electronics 72 and in turn the signals generated by sensor electronics 72 are fed to microcontroller 73. As known in the art, such microcontrollers 73 include electronics for controlling multiple functions and can be designed as an integrated circuit or any similar data analyzing device. In accordance with the invention, the microcontroller 73 receives signals generated in sensor electronics 72 and responds to transmit appropriate signals by way of extend/retract mechanism 74 to electric motor 70 to thereby extend or retract bumper portion 10A, and when appropriate, transmit signals by way of locking mechanism 75 to either unlock or lock locking mechanism 71. Although shown separately, sensor electronics 72 can be combined integrally with the microcontroller 73. A power source, grounding and on/off control as may be appropriate is indicated.

Although not shown, it is to be understood that in accordance with the invention a hydraulic system can be used instead of electrical means for both the retracted and extended mode. That is, a hydraulic pump with reservoir and an associated hydraulic cylinder can be substituted for electric motor 70 and cylinder 10d, respectively. Further, as will be understood, microcontroller 73 may be configured for either automatic operation of the apparatus of the invention or for on-demand manual operation.

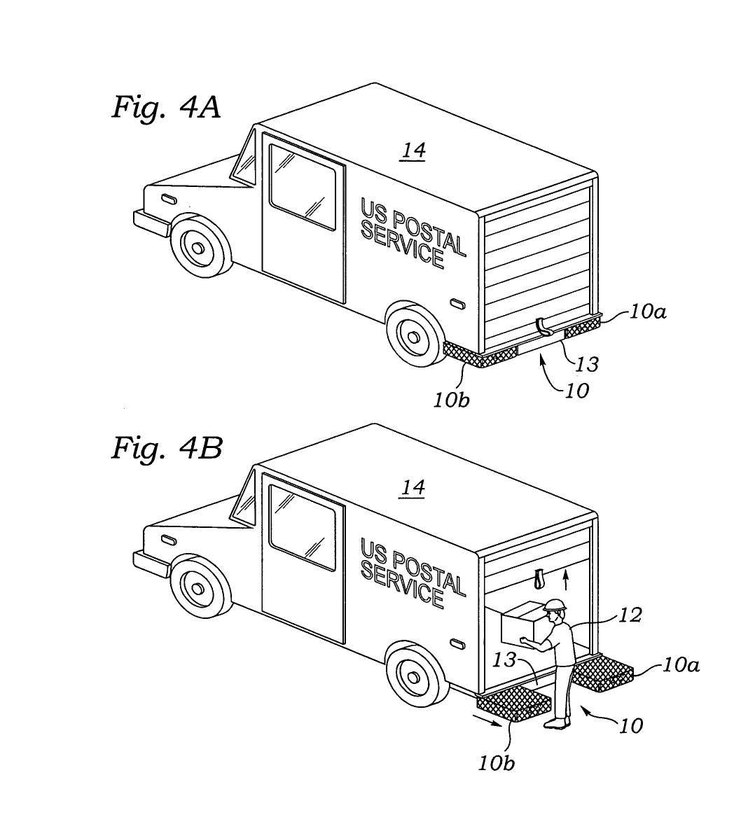

FIGS. 4A and 4B illustrate in perspective view an embodiment of the bumper protection apparatus 10 installed in a medium sized truck or van 14 in the retracted position or mode (FIG. 4A) and in the fully extended position or mode (FIG. 4B). As indicated the apparatus 10 can be formed to be a part of the rear bumper 13.

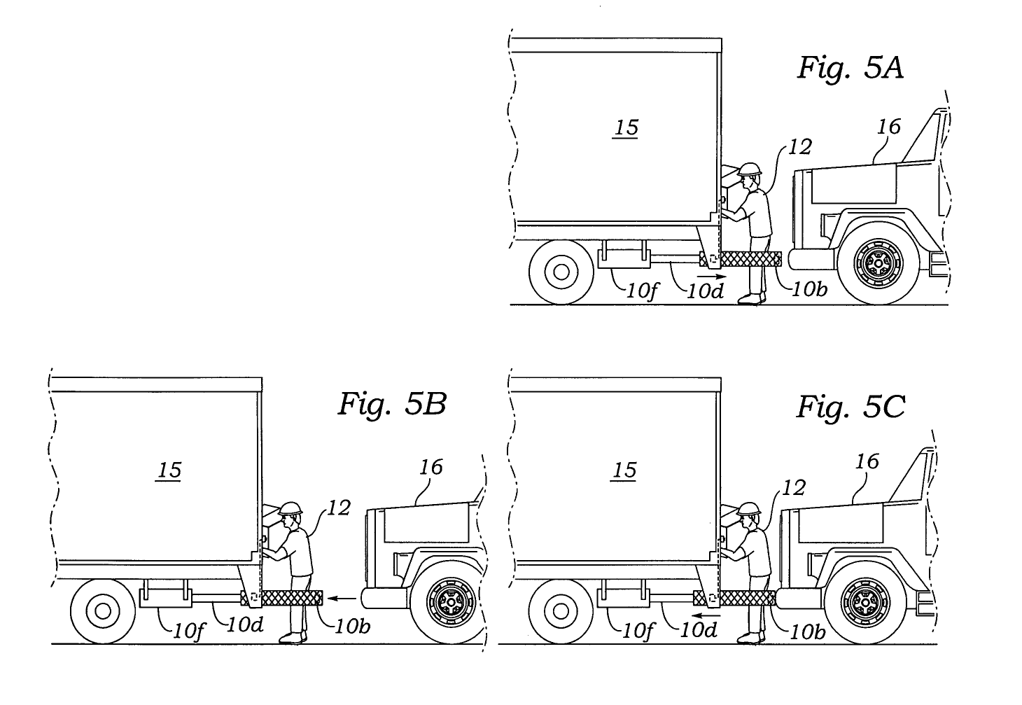

FIG. 5A-FIG. 5C illustrate in side view the bumper protection apparatus 10 installed underneath a large truck, and if suitable, independent of any other rear impact protection that the truck may have. FIG. 5A illustrates the apparatus 10 in the extendable mode wherein a protected work space is provided for the person 12 between the vehicle 15 and the vehicle 16. Also shown is safety bumper portion 10b with associated extension rod 10c and safety bumper cylinder 10d.

FIG. 5B illustrates vehicle 16 approaching the person 12 in the work space created by the apparatus 10 of the invention with FIG. 2C illustrating contact by vehicle 16 with the apparatus 10. As indicated the shock absorber means 10e of bumper portion 10a operates to cushion the impact of the vehicle 16 while still maintaining a sufficient safety space for the person 12.

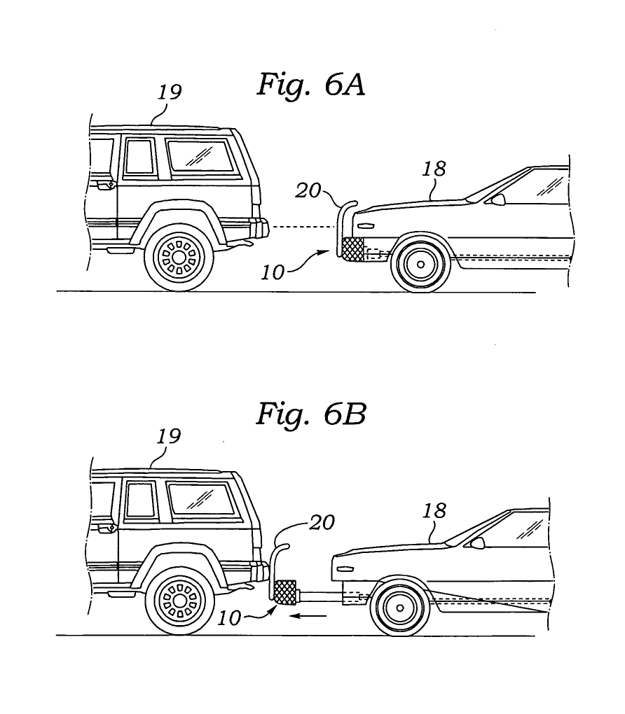

FIGS. 6A and 6B illustrate in side view another embodiment of the bumper protection apparatus in accordance with the invention wherein bumper apparatus 10 has been modified to include an upright guard portion 20 for protection against vehicle, such as vehicle 19, having raised rear ends. The bumper apparatus 20 installed in vehicle 18 is shown retracted in FIG. 6A and extended in FIG. 6B to prevent impact by the vehicle 19 as well as to establish egress space for vehicle 18 as needed.

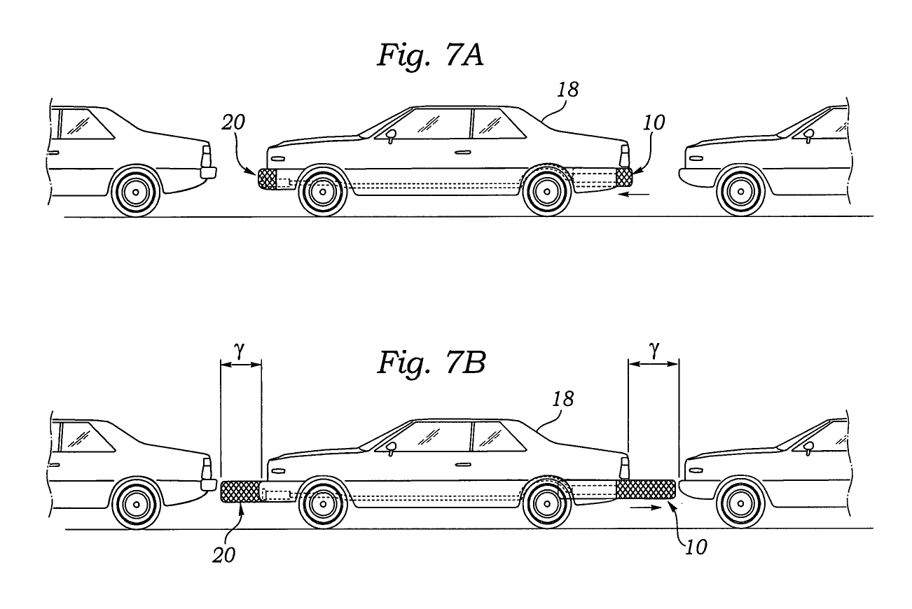

FIGS. 7A and 7B illustrate in side view bumper protection apparatus 10 mounted to the rear end of the vehicle 18 and bumper protection apparatus 20 mounted to the front end of the vehicle 18. Bumper apparatus 10 and bumper apparatus 20 are shown retracted (FIG. 7A) during parking and extended (FIG. 7B) after parking to prevent undesirable encroachment by other vehicles as well as to establish egress space as needed, retraction of all apparatus being made as desired to permit egress.

Although the present invention has been described in connection with example embodiments thereof, it will be appreciated by those skilled in the art that additions, deletions, substitutions, and other modifications not specifically described herein may be made without departing from the spirit and scope of the invention.

What is claimed is:

1. Vehicle bumper safety apparatus comprising:
a) at least one bumper portion having means for extension from and retraction to a vehicle;
b) said at least one bumper portion including sensor means for detection of close proximity objects;
c) converter means for converting signals from said sensor means to responsive electronics; and
d) a microcontroller for processing said responsive electronics to produce signals for activating said means for extension or retraction of said at least one bumper portion depending on the signals from said sensor means.

2. The apparatus of claim 1 including a pair of bumper portions extendable from said vehicle to define a protected work space.

3. The apparatus of claim 2 wherein said pair of bumper portions are displaced laterally along the rear of said vehicle for extension therefrom.

4. The apparatus of claim 3 wherein said pair of bumper portions are located one on each end of the rear bumper of said vehicle.

5. The apparatus of claim 4 wherein said pair of bumper portions are configured and arranged to form a part of said rear bumper.

6. The apparatus of claim 2 wherein said means for extension from and retraction to a vehicle include locking means for locking said bumper portions in selected extension positions.

7. The apparatus of claim 2 wherein said bumper portions include shock absorber means for compression in response to impact and said microcontroller includes means for automatically unlocking said locking means in response to predetermined impact.

8. The apparatus of claim 7 wherein said sensor means detects the proximity of said objects and said controller microcontroller includes means for automatically extending and retracting said bumper portions in response to predetermined signals from said sensor means.

9. The apparatus of claim 7 wherein said microcontroller includes alert means for informing the operator of said vehicle of the extension status of said bumper portions and said safety apparatus includes means for manually extending and retracting said bumper portions.

10. A vehicle safety mechanism comprising:
a) bumper means configured for extension and retraction from said vehicle;
b) sensor means in said bumper means for monitoring objects in immediate proximity of said vehicle; and
c) a microcontroller for processing signals from said sensor means for controlling the extension and retraction of said bumper means.

11. The vehicle safety mechanism of claim 10 wherein said bumper means includes bumper portions extendable from said vehicle to define a protected work space.

12. The vehicle safety mechanism of claim 11 wherein said microcontroller includes means for automatically extending and retracting said bumper portions in response to predetermined signals from said sensor means.

13. The vehicle safety mechanism of claim 11 wherein said mechanism includes alert means for informing the operator of said vehicle of the extension status of said bumper portions.

14. The vehicle safety mechanism of claim 13 wherein said microcontroller includes manually switched means for extending and retracting said bumper portions.

15. The vehicle safety mechanism of claim 10 wherein said mechanism includes locking means for locking said bumper portions in selected extension positions and said bumper portions include shock absorber means for compression in response to impact and said microcontroller includes means for automatically unlocking said locking means in response to predetermined impact.

16. Vehicular safety apparatus comprising:
sensor means for monitoring objects in immediate proximity of at least one end of a vehicle;
bumper means mounted on s aid at least one end of a vehicle configured for extension and retraction from said vehicle; and
a controller for processing signals from said sensor means for conformance with pre-selected requirements and activating said bumper means for extension or retraction from said vehicle;

17. The apparatus of claim 16 wherein said bumper means include two bumper portions that are extendable to define a protected work space.

18. The apparatus of claim 17 including locking means for locking said bumper portions in selected extension positions, said bumper portions include shock absorber means for compression in response to impact, and said controller includes means for automatically unlocking said locking means in response to predetermined impact.

19. The apparatus of claim 18 wherein said sensor means senses occupation of said work place and upon impact said controller automatically locks said bumper portions to sufficiently maintain said protected work place.

20. The vehicle safety mechanism of claim 11 wherein said mechanism includes means for alerting the operator of said vehicle of the extension status of said bumper portions and said microcontroller includes manually switched means for extending and retracting said bumper portions.
